(19) United States
(12) Patent Application Publication
(10) Pub. No.: US 2002/0183148 A1
(43) Pub. Date: Dec. 5, 2002

(54) Apparatus and method for monitoring chain pull

(76) Inventor: Robert Goryca, Livonia, MI (US)

Correspondence Address: DICKINSON WRIGHT PLLC, Suite 800, 1901 L. Street, N.W., Washington, DC, 20036, US

(21) Appl. No.: 09/870,505

(22) Filed: Jun. 1, 2001

(51) Int. Cl. F16H 7/12; F16H 7/22

(52) U.S. Cl. 474/114; 474/102; 474/115; 474/117

(57) ABSTRACT

Apparatus and method for monitoring chain pull of a conveyor drive that includes a conveyor drive having a fixed frame, a moveable frame, a spring assembly and a sensor assembly. The moveable frame supports a motor and is biased against the fixed frame by the spring assembly to oppose a force generated by the conveyor drive chain pull. The sensor assembly can be installed or removed without disassembly of the spring assembly and preferably without substantial interruption to the operation of the conveyor drive.

### FIELD OF THE INVENTION

The present invention is directed to apparatus and method for monitoring chain pull. In particular, the present invention is related to apparatus and method for monitoring chain pull, which do not required the disassembly of the conveyor drive.

### BACKGROUND ART

Many conveyor systems use chains as the driving mechanism and use conveyor drives to give the chains motion and control the speed of the conveyor chains. One example of this type of conveyor systems is a power and free conveyor system. A power and free conveyor system is generally made up of a power track, a free track, and trolleys capable of travelling along the free track. Generally, two trolleys, a leading trolley and a trailing trolley, support a carrier, which then supports a load or article being conveyed. Each leading trolley includes a driving dog which extends towards the power track and which is engageable with a pusher dog carried by a moving conveyor chain on the power track. When the pusher dog and the driving dog are engaged, the leading trolley (and the carrier) is pushed along the free track by the moving chain. When the driving dog is retracted, or otherwise disengaged from the pusher dog, the trolley stops moving, thus halting the carrier.

To move the chain, one or more conveyor drives are utilized. A commonly used conveyor drive uses a caterpillar chain to transmit its driving force to the conveyor chain. The caterpillar chain is made of precision steel rollers with driving dogs that mesh with a portion of the conveyor chain.

A conveyor drive may be either a fixed drive or a moveable drive. A moveable drive can be either a linear type or a rotary type. The linear type is generally built with a moveable frame that is guided and supported by ball bearing wheels attached to an outer fixed frame. In contrast, a rotary drive is mounted on a moveable frame that pivots relative to the fixed frame. One or more coil springs, placed between the fixed and moveable frames, may be used to counterbalance the chain pull and to control the movement of the moveable frame.

A prior art conveyor drive may include a fixed frame and a moveable frame pivotable relative to the fixed frame. A spring is disposed between the fixed frame and the moveable frame. The force of the spring biases the movable frame against the fixed frame and opposes the force caused by chain pull.

The moveable frame supports a speed reducer that has an input shaft and an output shaft. The input shaft is connected to a motor via a pulley, and the output shaft is connected to a drive sprocket.

The caterpillar chain exerts a chain pull force on the sprocket (and thus the moveable frame). This force is balanced by the spring and can be monitored by a strain gauge sensor which is used to measure the chain pull force. The strain gauge sensor is installed on a rod. One end of the rod is attached to the fixed frame, and the other end of the rod is secured to the spring. As installed in the conveyor drive, the strain gauge sensor directly measures the spring force. However, because the spring force is related to the chain pull force, the strain gauge sensor can indirectly measure the chain pull force.

One of the disadvantages of the prior art conveyor drive is that the strain gauge sensor is expensive and time-consuming to install or remove. It is especially so when a strain gauge sensor is only used periodically to monitor chain pull, thus requiring frequent installations and removals of the strain gauge sensor, resulting in substantial downtime for the conveyor system. For each installation or removal of the strain gauge sensor, the conveyor drive must be stopped and the spring assembly must be disassembled and reassembled. Alternatively, a permanent strain gauge sensor may be installed in each conveyor drive, thus eliminating the need for frequent installations and removals. However, this approach is costly because it requires that each conveyor drive be provided with a strain gauge sensor and data acquisition equipment.

Consequently, a need has developed to provide cost-effective, less interruptive, and less time-consuming methods and apparatus for monitoring the chain pull in conveyor systems.

### SUMMARY OF THE INVENTION

The present invention meets this need by providing a simple but effective sensor assembly which can be installed or removed without the need to disassemble the spring assembly and preferably without substantial interruption to the operation of the conveyor system. The invention also provides a method to install or remove a sensor assembly with the same advantages.

In accordance with one aspect of the invention, a conveyor drive includes a fixed frame, a moveable frame operatively associated with the fixed frame, a spring assembly connectable to both frames, and a sensor assembly. The moveable frame supports a motor. The spring assembly biases the moveable frame against the fixed frame and opposes a force generated by chain pull. The sensor assembly is connectable between one of the frames, and one of the spring assembly and the other frame. When the sensor assembly is connected between one of the frames and one of the spring assembly and the other frame, the force is transmitted substantially through the sensor assembly and is not transmitted substantially through the spring assembly.

In accordance with another aspect of the invention, a conveyor drive includes a fixed frame, a moveable frame operatively associated with the fixed frame, a spring assembly connectable to both frames, and a sensor assembly. The moveable frame supports a motor. The spring assembly biases the moveable frame against the fixed frame and opposes a force generated by chain pull. The spring assembly is connectable between one of the frames, and one of the spring assembly and the other frame. The sensor assembly includes an adjusting mechanism, which allows the force to be transmitted substantially through the sensor assembly and not to be transmitted substantially through the spring assembly.

In accordance with yet another aspect of the invention, a conveyor drive includes a fixed frame, a moveable frame operatively associated with the fixed frame, a spring assembly connectable to both frames, and a sensor assembly. The moveable frame supports a motor. The spring assembly biases the moveable frame against the fixed frame and opposes a force generated by chain pull. The spring assembly includes a cylindrical housing connected to one of the frames, and a spring. The spring is disposed in the cylindrical housing and connected to the cylindrical housing, and is connectable to the other frame. The sensor assembly includes a first member connectable to the spring assembly, a second member connectable to the other frame, a sensor connectable to the first and second members, and an adjusting mechanism connectable to the first and second members. The adjusting mechanism is capable of adjusting the relative position of the first and second members so that the force is transmitted substantially through the sensor.

In accordance with a further aspect of the invention, a sensor assembly for monitoring chain pull of a conveyor drive includes first and second members, a sensor and an adjusting mechanism. The conveyor drive having a fixed frame, a moveable frame operatively associated with the fixed frame, and a spring assembly connectable to both frames and opposing a force generated by chain pull. The spring assembly includes a cylindrical housing connected to one of the frames, and a spring that is disposed in the cylindrical housing, connected to the cylindrical housing and connectable to the other frame. The first member is connectable to one of the cylindrical housing and the spring, and the second member is connectable to the other frame. The sensor is connectable to the first and second members, and the adjusting mechanism is connectable to the first and second members. The adjusting mechanism is capable of adjusting the relative position of the first and second members so that the force is transmitted substantially through the sensor.

A yet further aspect of the invention is directed to a method for installing a sensor assembly for monitoring chain pull of a conveyor drive that has a fixed frame, a moveable frame operatively associated with the fixed frame, and a spring assembly that is connectable to both frames and opposes a force generated by chain pull. The spring assembly includes a cylindrical housing connected to one of the frames, and a spring that is disposed in the cylindrical housing, connected to the cylindrical housing, and connectable to the other frame. The method includes the steps of connecting a first member of the sensor assembly to one of the cylindrical housing and the spring, connecting a second member to the other frame, connecting a sensor to the first and second members, and adjusting the relative position between the first and second members so that the force is transmitted substantially through the sensor.

### BRIEF DESCRIPTION OF THE DRAWINGS

Reference is now made to the drawings of the invention wherein:

FIG. 1 shows a conveyor drive.

FIG. 2 shows a sensor assembly of the present invention that is installed in a conveyor drive for monitoring chain pull.

### DESCRIPTION OF THE PREFERRED EMBODIMENTS

The following description of the presently preferred embodiments of the invention refers to the accompanying drawings. The description is directed to and the drawings show exemplary embodiments of the invention, other embodiments are possible, and changes may be made to the embodiments described below without departing from the spirit and scope of the invention. The scope of the invention is defined by the appended claims. The description and drawings are merely illustrative, not limiting.

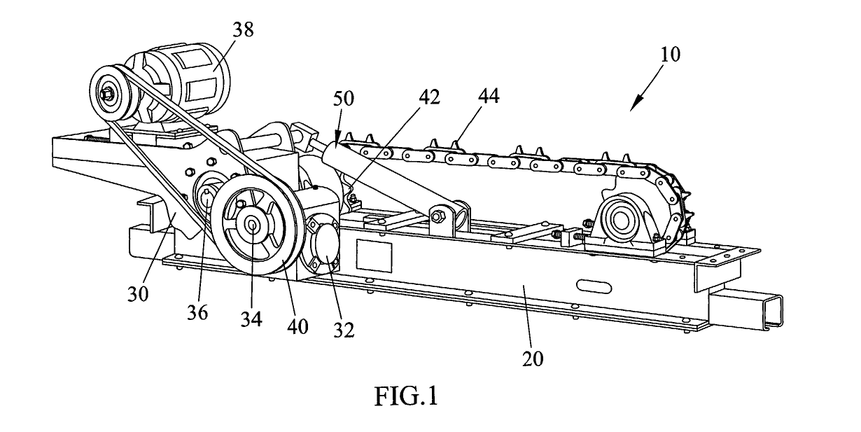

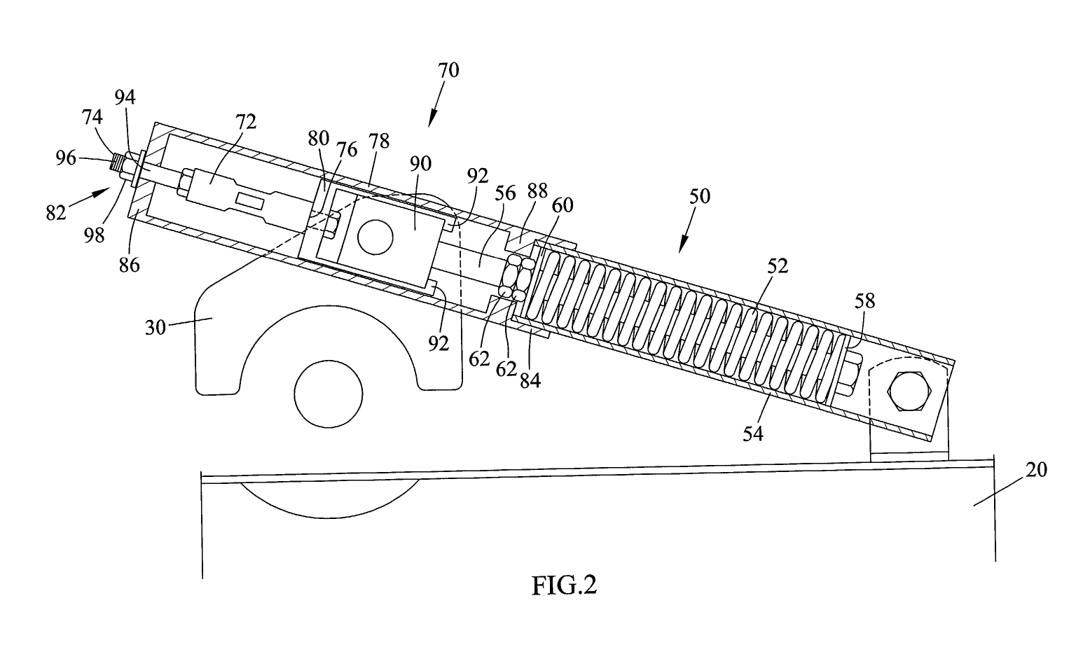

FIGS. 1 and 2 show a conveyor drive 10 embodying one aspect of the invention. The conveyor drive 10 includes a fixed frame 20, a moveable frame 30 pivotable about the fixed frame 20, a spring assembly 50 disposed between the fixed frame 20 and the moveable frame 30, and a sensor assembly 70 (only shown in FIG. 2). One of the differences between this conveyor drive 10 and a prior art conveyor drive is that the sensor assembly 70 of the conveyor drive 10 can be installed or removed without the need to disassemble the spring assembly 50 and preferably without substantial interruption to the operation of the conveyor system.

In the illustrated embodiment, the moveable frame 30 is pivotably connected to the fixed frame 20. The moveable frame 30 may support a speed reducer 32 that has an input shaft 34 and an output shaft 36. The input shaft 34 is connected to a motor 38 via a pulley 40, and the output shaft 36 is connected to a drive sprocket 42 that drives the caterpillar chain 44 of the conveyor drive 10. The speed reducer 32 allows the drive sprocket 42 to rotate at a slower speed than the motor 38 does. The speed reducer may employ any suitable mechanism to reduce the speed. For example, the speed reducer 32 may employ a gear arrangement. Alternatively, the speed reducer 32 may employ a pulley/belt arrangement. If it is desired to have the drive sprocket 42 rotate at a higher speed than the motor 38 does, the speed reducer 32 may be replaced with a device that increases the speed. Further, if the drive sprocket 42 can operate at the same speed as the motor 38, then a speed reducer may not be needed. Although the conveyor drive 10 shown in FIGS. 1 and 2 is of the rotary type, i.e., the moveable frame 30 can pivot relative to the fixed frame 20, it can also be of the linear type, i.e., the moveable frame can move linearly relative to the fixed frame.

In operation, the caterpillar chain 44 is under certain tension, which applies a chain pull force on the drive sprocket 42 (and the moveable frame 20). This chain pull force tends to cause the moveable frame 20 to pivot in one direction. The spring assembly may be any suitable device which can be used to balance the force exerted on the moveable frame 30 by the chain pull. The spring assembly 50 shown in FIGS. 1 and 2 may use any suitable type of spring. In the illustrated conveyor drive 10, for example, the spring assembly 50 uses a coil spring 52 (see FIG. 2). Alternatively, the spring assembly 50 may use any other type of spring, such as a leaf spring. In addition to the spring 52, the spring assembly 50 may also include a cylindrical housing 54 connected to the fixed frame 20 and a rod 56 connected to the moveable frame 30. Preferably, the coil spring 52 is disposed in the housing 54, and it is placed between a stop 58 fixed to the inner surface of the cylindrical housing 54 and a plate 60 connected to the rod 56. The rod 56 extends through an orifice on the plate 60, and two nuts 62 mounted on the rod 56 abut the plate 60. When a chain pull force is applied to the moveable frame 30, the moveable frame 30 may compress the coil spring 52 through the rod 56 and the plate 60, creating a balance force against the chain pull force.

The spring assembly of the present invention may have a number of alternatives. For example, the cylindrical housing 54 may be connected to the moveable frame 30, while the rod 56 may be connected to the fixed frame 20. In addition, the spring 52 may be connected directly to the frames 20, 30 without the use of the housing 54 and rod 56. Further, the spring assembly may be a spring-loaded torque arm assembly, which is a part of the drive overload protection system. In the case of a torque arm assembly, the spring is pre-compressed, and during operation it is not further compressed until the conveyor drive is near its capacity to protect the conveyor drive from overloading. If desired, the spring assembly may also include a damper to provide a certain of damping to the spring assembly.

In general, the sensor assembly preferably includes a sensor having first and second ends, which may be connected to the frames 20, 30 and/or the spring assembly 50 without the need to disassemble the spring assembly 50. When the sensor is so connected, the force countering the chain pull force preferably is substantially transmitted through the sensor, allowing the sensor to monitor the chain pull force. The sensor assembly may also include an adjusting mechanism, which may be used disengaged the spring assembly so that the force countering the chain pull force preferably is substantially transmitted through the sensor.

In the illustrated embodiment, the sensor assembly 70 shown in FIG. 2 includes a sensor 72 having an elongated configuration with first and second ends 74, 76, first and second members 78, 80, and an adjusting mechanism 82. The first member 78 may be a tubular housing having first and second ends 84, 86. The tubular housing 78 includes an inner stop 88 near its first end 84, and the inner stop 88 abuts an end of the cylindrical housing 54 of the spring assembly 50. The end of the cylindrical housing 54 preferably extends into the tubular housing 78 to ensure that the cylindrical housing 54 is aligned with the tubular housing 78.

The second member 80 shown in FIG. 2 preferably is an attachment in the form of a coupling bracket. The second member 80 may be coupled to a clevis 90 which connects the rod 56 of the spring assembly 50 to the moveable frame 30. The second member 80 preferably includes hooks 92 that allow the second member 80 to capture the clevis 90. Alternatively, the second member may include any suitable attachment, such as a clamp or fastener, for attachment to the clevis 90 or the moveable frame 30. Preferably, the second member 80 is disposed inside the first member 78 and is coaxially arranged with the first member 78.

The sensor may be of any suitable type. For example, the sensor may be a strain gauge sensor or a piezoelectric sensor. In the illustrated embodiment, the sensor 72 preferably is connected to the first and second members 78, 80. The first end 74 of the sensor 72 may extend through an opening 94 on the second end 86 of the tubular housing 78 to the outside of the tubular housing 78, and the second end 76 of the sensor 72 is connected to the second member 80. Preferably, the sensor 72 is disposed inside the first member 78 and is coaxially arranged with the first and second members 78, 80.

In the illustrated embodiment, the adjusting mechanism 82 includes threads 94 on the first end 74 of the sensor 72 and a nut 96 mounted on the threaded first end 74 of the sensor 72. By turning the nut 96, the relative position between the first and second members 78, 80 can be adjusted, pulling the rod 56 away from the spring 52 to disengage the rod 56 from the spring 52, so that the force is substantially transmitted through the sensor 72, allowing the sensor 72 to measure the chain pull force. An alternative to the adjusting mechanism shown in FIG. 2 may include the nuts 62 threaded on the rod 56, and the spring assembly 50 can be disengaged by turning the nuts 62 on the rod 56 until the rod 56 is disengaged from the spring 52, allowing the force to be transmitted substantially through the sensor 72. In general, the adjusting mechanism may be any mechanism that can disengage the spring assembly and allows the chain pull force to be transmitted substantially through the sensor assembly 70 and preferably is not transmitted substantially through the spring assembly 50.

The invention as claimed herein may have many alternatives to the embodiment described above. For example, while the sensor assembly 70 shown in FIG. 2 is connected to the cylindrical housing 54 of the spring assembly 50, a sensor assembly may be connected to the spring 52 or the plate 60. Then an adjusting mechanism may be used to compress the spring 52 or the plate 60 to disengage the spring 52 from the rod 56, so the chain pull force is transmitted substantially through the sensor assembly 50. In another embodiment, a sensor assembly may be connected directly to the frames 20, 30 or to any components connected to the frames 20, 30. Then the distance between the connecting points may be expanded to disengage the spring assembly 50.

The installation or removal of the sensor assembly of the present invention can be performed without the need for disassembly of the spring assembly and preferably without substantial interruption to the operation of the conveyor drive. As defined herein, “substantial interruption” means any stoppage of conveyor drive operation that is more than five minutes, more preferably less than two minutes, most preferably less than one minute. In some cases, the operation of the conveyor drive need not be stopped at all. As one of the first steps in installing the sensor assembly 70, using the embodiment shown in FIGS. 1 and 2 as an example, the second member 80 of the sensor assembly 70 may be mounted on the clevis 90, with the sensor 72 connected to the second member 80 or with the sensor 72 installed afterwards. Then the first member 78 may be installed with the inner stop 88 abutting an end of the cylindrical housing 54 of the spring assembly 50 and with the sensor 72 and the second member 80 placed within the first member 78. At the same time, the first end 74 of the sensor 72 should extend through the opening 94 on the second end 86 of the first member 78 to the outside of the first member 78. Next a nut 96 may be mounted on the threaded first end 74 of the sensor 72 and turned until the rod 56 is substantially disengaged from the spring 52 so that the force is transmitted substantially through the sensor 72. The removal of the sensor assembly 70 is substantially the reverse of the steps described above.

Some of the steps described above may be performed with the conveyor drive in operation, while others may be performed with conveyor drive shutdown. For example, while the installation of the first and second members 78, 80 may be installed with the conveyor drive 10 in operation, the adjustment of the nut 96 may be performed with the conveyor drive 10 shutdown.

1. A conveyor drive comprising:
a fixed frame;
a moveable frame operatively associated with the fixed frame, the moveable frame supporting a motor;
a spring assembly connectable to both frames, the spring assembly biasing the moveable frame against the fixed frame and opposing a force generated by chain pull; and
a sensor assembly connectable between one of the frames and one of the spring assembly and the other frame, wherein when the sensor assembly is connected between one of the frames and one of the spring assembly and the other frame, the force is transmitted substantially through the sensor assembly and is not transmitted substantially through the spring assembly.

2. The conveyor drive of claim 1, wherein the sensor assembly is connected between one of the frames and one of the spring assembly and the other frame, and the force is transmitted substantially through the sensor assembly.

3. The conveyor drive of claim 2, wherein the spring assembly includes a cylindrical housing connected to one of the frames, a spring disposed in the cylindrical housing and connected to the cylindrical housing, the spring being connectable to the other frame.

4. The conveyor drive of claim 3, wherein the sensor assembly includes:
a first member connectable to the spring assembly;
a second member connectable to the other frame;
a sensor connectable to the first and second members; and
an adjusting mechanism connectable to the first and second members, the adjusting mechanism being capable of adjusting the relative position of the first and second members so that the force is transmitted substantially through the sensor.

5. The conveyor drive of claim 4, wherein the first member includes a tubular housing having first and second ends, and the first end of the tubular housing is connectable to the cylindrical housing of the spring assembly.

6. The conveyor drive of claim 5, wherein the tubular housing includes an inner circumferential stop near its first end, the inner circumferential stop being connectable to the cylindrical housing of the spring assembly.

7. The conveyor drive of claim 5, wherein the second member includes an attachment for connection with the other frame.

8. The conveyor drive of claim 7, wherein the attachment includes a coupling bracket.

9. The conveyor drive of claim 5, wherein the second member is disposed between the first and second ends of the first member.

10. The conveyor drive of claim 9, wherein the second member is disposed inside the first member and is coaxially arranged with the first member.

11. The conveyor drive of claim 9, wherein the sensor has an elongated configuration with first and second ends.

12. The conveyor drive of claim 9, wherein the sensor is disposed inside the first member and is coaxially arranged with the first and second members.

13. The conveyor drive of claim 10, wherein the second end of the first member includes an opening, the first end of the sensor extends through the opening.

14. The conveyor drive of claim 11, wherein the adjusting mechanism includes threads on the first end of the sensor and a nut mounted on the threaded first end of the sensor, wherein the relative position between the first and second members can be adjusted by turning the nut so that the force is transmitted substantially through the sensor and not substantially through the spring assembly.

15. A conveyor drive comprising:
a fixed frame;
a moveable frame operatively associated with the fixed frame, the moveable frame supporting a motor;
a spring assembly connectable to both frames, the spring assembly biasing the moveable frame against the fixed frame and opposing a force generated by chain pull; and
a sensor assembly being connectable between one of the frames and one of the spring assembly and the other frame, the sensor assembly including an adjusting mechanism, wherein the adjusting mechanism allows the force to be transmitted substantially through the sensor assembly and not to be transmitted substantially through the spring assembly.

16. The conveyor drive of claim 15, wherein the sensor assembly is connected between one of the frames and one of the spring assembly and the other frame, and the force is transmitted substantially through the sensor assembly.

17. The conveyor drive of claim 16, wherein the spring assembly includes a cylindrical housing connected to one of the frames, a spring disposed in the cylindrical housing and connected to the cylindrical housing, the spring being connectable to the other frame.

18. The conveyor drive of claim 17, wherein the sensor assembly includes:
a first member connectable to the spring assembly;
a second member connectable to the other frame; and
a sensor connectable to the first and second members, wherein the adjusting mechanism connectable to the first and second members, the adjusting mechanism being capable of adjusting the relative position of the first and second members so that the force is transmitted substantially through the sensor.

19. A conveyor drive comprising:
a fixed frame;
a moveable frame operatively associated with the fixed frame, the moveable frame supporting a speed reducer;
a spring assembly connectable to both frames and opposing a force generated by chain pull, the spring assembly including:
a cylindrical housing connected to one of the frames, and
a spring disposed in the cylindrical housing and connected to the cylindrical housing, the spring being connectable to the other frame; and
a sensor assembly including:
a first member connectable to the spring assembly,
a second member connectable to the other frame,
a sensor connectable to the first and second members, and
an adjusting mechanism connectable to the first and second members, the adjusting mechanism being capable of adjusting the relative position of the first and second members so that the force is transmitted substantially through the sensor.

20. A sensor assembly for monitoring chain pull of a conveyor drive that has a fixed frame, a moveable frame operatively associated with the fixed frame, and a spring assembly connectable to both frames and opposing a force generated by chain pull, the spring assembly including a cylindrical housing connected to one of the frames, and a spring disposed in the cylindrical housing and connected to the cylindrical housing, the spring being connectable to the other frame, the sensor assembly comprising:
a first member connectable to one of the cylindrical housing and the spring;
a second member connectable to the other frame;
a sensor connectable to the first and second members; and
an adjusting mechanism connectable to the first and second members, the adjusting mechanism being capable of adjusting the relative position of the first and second members so that the force is transmitted substantially through the sensor.

21. The sensor assembly of claim 20, wherein the first member includes a tubular housing having first and second ends, and the first end of the tubular housing is connectable to the cylindrical housing of the spring assembly.

22. The sensor assembly of claim 21, wherein the tubular housing includes an inner circumferential stop near its first end, the inner circumferential stop being connectable to the cylindrical housing of the spring assembly.

23. The sensor assembly of claim 22, wherein the second member includes an attachment for connection with the other frame.

24. The sensor assembly of claim 23, wherein the attachment includes a coupling bracket.

25. The sensor assembly of claim 21, wherein the second member is disposed between the first and second ends of the first member.

26. The sensor assembly of claim 25, wherein the sensor has an elongated configuration with first and second ends.

27. The sensor assembly of claim 26, wherein the second end of the first member includes an opening, the first end of the sensor extends through the opening.

28. The sensor assembly of claim 27, wherein the adjusting mechanism includes threads on the first end of the sensor and a nut mounted on the threaded first end of the sensor, wherein the relative position between the first and second members can be adjusted by turning the nut so that the force is transmitted substantially through the sensor and not substantially through the spring assembly.

29. A method for installing a sensor assembly for monitoring chain pull of a conveyor drive that has a fixed frame, a moveable frame operatively associated with the fixed frame, and a spring assembly connectable to both frames and opposing a force generated by chain pull, the spring assembly including a cylindrical housing connected to one of the frames, and a spring disposed in the cylindrical housing and connected to the cylindrical housing, the spring being connectable to the other frame, the method comprising:
connecting a first member of the sensor assembly to one of the cylindrical housing and the spring;
connecting a second member to the other frame;
connecting a sensor to the first and second members; and
adjusting the relative position between the first and second members so that the force is transmitted substantially through the sensor.

30. The method of claim 29, wherein the first member includes a tubular housing having first and second ends, and the step of connecting a first member to one of the cylindrical housing and the spring includes connecting the first end of the tubular housing to the cylindrical housing of the spring assembly.

31. The method of claim 30 further including placing the second member within the tubular housing between the first and second ends of the tubular housing.

32. The method of claim 31, wherein connecting the second member to the other frame includes connecting the second member to the other frame using a coupling bracket.

33. The method of claim 31, wherein the step of connecting the first end of the tubular housing to the cylindrical housing of the spring assembly includes abutting an inner circumferential stop of the tubular housing against the cylindrical housing of the spring assembly.

34. The method of claim 29, wherein the step of connecting a sensor to the first member includes extending an end of the sensor through an opening on the second end of the first member.

35. The method of claim 34, wherein the step of connecting a sensor to the first member further includes extending a threaded end of the sensor through an opening on the second end of the first member.

36. The method of claim 35 further including placing a nut on the threaded end of the sensor.

37. The method of claim 36, wherein adjusting the relative position between the first and second members includes turning the nut to adjust the relative position between the first and second members.
